(19) United States
(12) Patent Application Publication
(10) Pub. No.: US 2015/0212659 A1
(43) Pub. Date: Jul. 30, 2015

(54) Multi-Persona Launcher

(71) Applicant: Tresys Technology, LLC, Columbia, MD (US)

(72) Inventors: William C. Roberts, Tracy, CA (US); Quentin M. Swain, Halethorpe, MD (US); Jeremy J. Solt, Takoma Park, MD (US)

(73) Assignee: Tresys Technology, LLC, Columbia, MD (US)

(21) Appl. No.: 14/163,884

(22) Filed: Jan. 24, 2014

(51) Int. Cl. G06F 3/0482; G06F 3/0484

(52) U.S. Cl. CPC G06F 3/0482; G06F 3/04842

(57) ABSTRACT

Systems and methods are provided for implementing a multi-persona launcher for a computing device. After a user has authenticated himself or herself to the computing device, embodiments of the present disclosure provide the user with the ability to launch applications under a variety of personas. For example, a mobile handset can detect a “dwell” event for a particular icon and can then display an option to launch the application associated with the icon under a variety of personas. The user can select to launch the application under either persona without having to log in again.

### FIELD OF THE INVENTION

This invention relates to user authentication and more specifically to user authentication for mobile devices.

### BACKGROUND

A user of a computing device, such as a mobile device, is often required to enter a password, code, or other identifying information to authenticate the user and/or to access the user's account. A user's account may be associated with multiple personas for a single user. These personas can be used to implement different settings, access restrictions, available data, etc. for a single user depending on the currently active persona for the user. Some mobile devices offer the user the ability to switch personas associated with a single user. For example, a user can switch between one persona used for personal use and another persona used for business use.

Switching personas or users on mobile devices currently requires the user to log out and back into the device or persona. For example, a user may be required to switch personas before launching an application under a different persona. This logging in and logging out procedure can be cumbersome and can fragment the user experience by requiring frequent user authentication input (e.g., login information).

What is needed are systems and methods for providing a more integrated user experience when switching between users or personas on a mobile device.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a block diagram of a computing device with an integrated multi-persona launcher in accordance with an embodiment of the present disclosure.

FIG. 2A is a block diagram illustrating icons on a screen of a mobile device in accordance with an embodiment of the present disclosure.

FIG. 2B is a block diagram illustrating an execution of a multi-persona launcher in accordance with an embodiment of the present disclosure.

FIG. 2C is a block diagram showing a system tray of a computing device displaying a default persona in accordance with an embodiment of the present disclosure.

FIG. 2D is a block diagram showing a menu for changing a default persona in accordance with an embodiment of the present disclosure.

FIG. 2E is a block diagram showing a menu for switching users in accordance with an embodiment of the present disclosure.

FIG. 2F is a block diagram illustrating a menu displaying a variety of user options for launching an application in accordance with an embodiment of the present disclosure.

FIG. 3A shows a block diagram illustrating a menu for changing users, personas, and permissions in accordance with an embodiment of the present disclosure.

FIG. 3B shows a diagram illustrating a menu for configuring users in accordance with an embodiment of the present disclosure.

FIG. 3C shows a diagram illustrating a menu for configuring personas in accordance with an embodiment of the present disclosure.

FIG. 4 is a flowchart of a method for launching an application using a multi-persona launcher in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### 1. OVERVIEW

Embodiments of the present disclosure provide systems and methods for implementing a multi-persona launcher for a computing device (e.g., a mobile handset). After a user has authenticated himself or herself to the computing device, embodiments of the present disclosure provide the user with the ability to launch applications under a variety of personas. For example, a mobile handset can detect a “dwell” event caused when a user presses an icon on the mobile handset screen and holds his or her finger down on the icon for a predetermined period of time. The mobile handset can then display an option to launch the application associated with the icon under a variety of personas (e.g., under a personal persona or a business persona). The user can select to launch the application under one or more of the variety of personas without having to log in under that persona.

### 2. PERSONAS

Many computing device owners use a single device for both business and personal use. Some issues can arise with using a personal device for business purposes, however. For example, a business may want to impose additional security measures on the mobile device to ensure that business data is not compromised. The user may also have different concerns (e.g., privacy). Thus, some mobile devices offer programs to meet the security needs of the business without interfering with the user's personal data.

One way to satisfy the needs of the user and the business is to enable the user to log on to the device under multiple personas. For example, a user can log into the device under his or her personal persona to use personal data and applications, and the user can log in to the device under his or her business persona to use business data and applications. By implementing personal and business personas, both business and personal data can exist on the same device without compromising the security needs of the business or the privacy needs of the user.

Some dual-persona systems require additional user input before a user is allowed to switch between personas. For example, if a user is currently using a mobile device to compose a personal email and wants to check business email, some dual-persona systems will require the user to log off and log back on again under his or her business, persona. After checking business email, the user has to then log off the business persona and log back into the personal persona to continue composing his or her personal email. Thus, this process requires additional undesirable user input, which can be time consuming and can fragment the user experience. Embodiments of the present disclosure reduce this required user input by providing a multi-persona launcher.

### 3. MULTI-PERSONA LAUNCHER

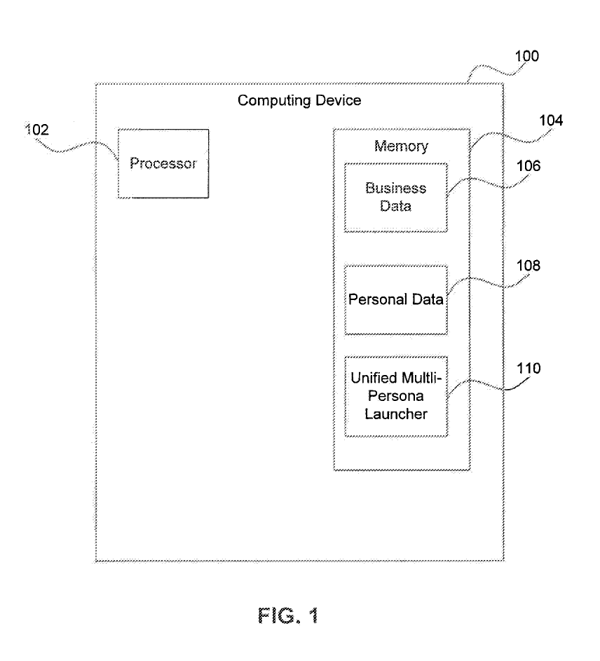

FIG. 1 is a block diagram of a computing device with an integrated multi-persona launcher (MPL) in accordance with an embodiment of the present disclosure. In an embodiment, computing device 100 is a mobile handset. However, it should be understood that computing device 100 can be any computing device in accordance with an embodiment of the present disclosure. For example, in an embodiment, computing device 100 can be a tablet computer, a laptop, a personal computer, etc.

In FIG. 1, MPL 110 is implemented as an application stored in memory 104 of computing device 100. In an embodiment, MPL 110 is built into the operating system of computing device 100 and auto-launches when computing device 100 boots up and/or when a user logs in to computing device 100. However, it should be understood that MPL 110 can be implemented in hardware or software in accordance with embodiments of the present disclosure. For example, in an embodiment, an MPL in accordance with an embodiment of the present disclosure can be implemented into computing device as a hardware module (e.g., as a separate integrated circuit of computing device 100). Additionally, in an embodiment, an MPL in accordance with an embodiment of the present disclosure can be implemented as a separate software module not stored in memory 104. For example, in an embodiment, an MPL in accordance with an embodiment of the present disclosure can be implemented in a separate memory of computing device 100 (e.g., a secure memory) that cannot be accessed by other programs and data stored in memory 104 of computing device 100.

As shown in FIG. 1, computing device 100 has a processor 102 and a memory 104 storing data, including business data 106 and personal data 108. In an embodiment, business data 106 includes applications and information that can be used when a user launches an application under his or her business persona. In an embodiment, personal data 108 includes applications and information that can be used when a user launches an application under his or her personal persona.

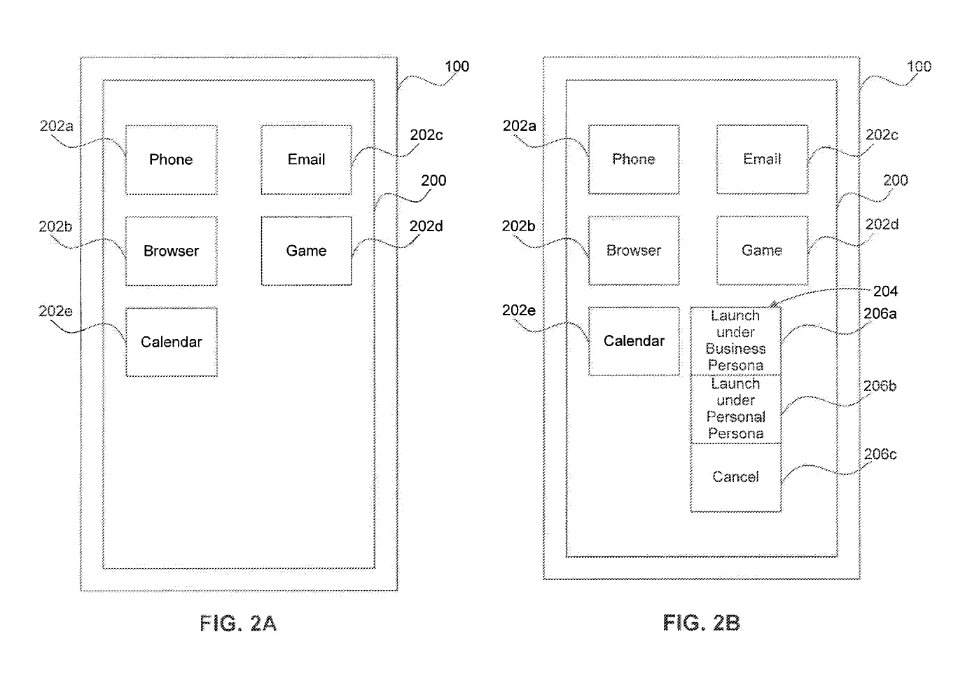

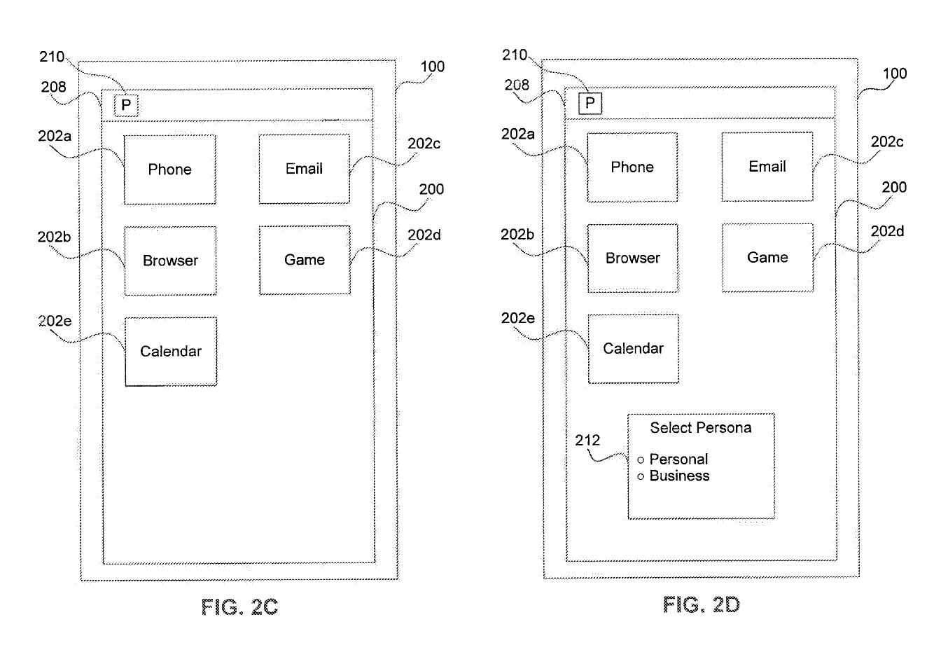

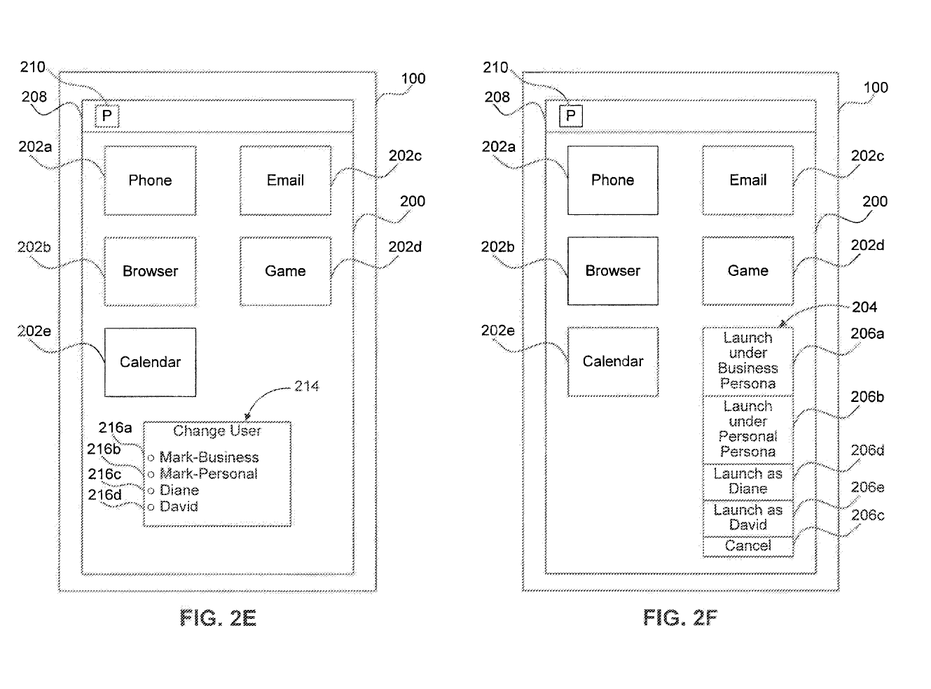

FIG. 2A is a block diagram illustrating icons on a screen of a computing device (e.g., computing device 100) in accordance with an embodiment of the present disclosure. In the exemplary embodiment shown in FIG. 2A, computing device 100 is a mobile device with a screen 200 displaying icons 202. However, it should be understood that computing device 100 can be any computing device in accordance with an embodiment of the present disclosure. For example, in an embodiment, computing device 100 can be a tablet computer, a laptop, a personal computer, etc. The icons 202 include icons for various applications (e.g., phone application 202a, browser application 202b, email application 202c, game application 202d, and calendar application 202e) that can be launched when a user provides a user input to the associated icon (e.g., when a user presses his or her finger on the associated icon).

In some conventional persona implementations, a user has to log out of a personal persona and log on under a business persona before launching an application associated with any of icons 202 under a business persona. Additionally, the user has to log out of a business persona and log on under a personal persona before launching an application associated with any of icons 202 under a personal persona. In accordance with an embodiment of the present disclosure, MPL 110 enables a user to launch any of applications 202 under either a business or a personal persona without having to log out and log back in under the appropriate persona.

FIG. 2B is a block diagram illustrating an execution of a multi-persona launcher in accordance with an embodiment of the present disclosure. When MPL 110 is implemented into computing device 100, MPL 110 provides a user with an option to launch an application under either a business persona or a personal persona via a user interface. For example, in an embodiment, a user can press and hold an icon for a predetermined period of time to initiate a “dwell” event. This dwell event can be detected (e.g., by the operating system of computing device 100 or by MPL 110), and MPL 110 can initiate a display of a menu 204 in response to this detected dwell event. In an embodiment, MPL 110 can access persona information (e.g., which personas are supported for the current user) in response to this dwell event and can use this persona information to generate menu 204. In an embodiment, menu 204 provides an option to launch an application under a business persona 206a, an option to launch the application under a personal persona 206b, and an option to cancel 206c. It should be noted that other personas can be included within menu 204 without departing from the spirit and scope of the present disclosure. For example, the menu 204 can include multiple business personas 206a and/or multiple personal personas 206b. Menu 204 can be a list menu, a pinwheel menu, or any other type of menu in accordance with an embodiment of the present disclosure.

For example, if a user presses and holds calendar icon 202e for a predetermined period of time (e.g., initiating a dwell event), MPL 110 initiates a display of menu 204, providing the option to launch a calendar application under a business persona 206, a personal persona 206b, or to cancel 206c. Alternatively, in an embodiment, a user can double click calendar icon 202e to initiate a display of menu 204. If the user chooses to launch calendar 202e under a business persona, the user presses menu option 206a, and MPL 110 can access business data 106 to launch the calendar. For example, in an embodiment, MPL 110 can access a specific calendar application associated with the user's business persona (e.g., storing business appointments) and can launch the application. If the user chooses to launch calendar 202e under a personal persona, the user presses menu option 206b, and MPL 110 can access personal data 108 to launch the calendar application. For example, in an embodiment, MPL 110 can access a specific calendar application associated with the user's personal persona (e.g., storing personal appointments) and can launch the application. If the user selects menu option 206c, MPL initiates a removal of menu 204 from the screen. In an embodiment, the application can be simply launched using the current persona of the computing device 100 when the user presses menu option 206c.

In an embodiment, MPL 110 can create and/or access a list of applications for use under supported personas. For example, in an embodiment, this list can include a path to a personal calendar application and to a business calendar application stored in memory 104. In an embodiment, this list of applications can be configured by a user. Additionally, in an embodiment, an initial list of applications can be auto-generated by scanning applications stored on computing device 100 when MPL 110 is installed and determining which applications are likely to be used under a business persona and which applications are likely to be used under a personal persona.

In an embodiment, a single application may be used under a business persona or a personal persona in accordance with an embodiment of the present disclosure. For example, a user may use a single calendar application for business and personal use, but the user may have separate accounts, separate instances of this application, or separate application data to separate his or her personal calendar from his or her business calendar. In an embodiment, MPL 110 can be configured to launch the application under the appropriate business or personal account, launch the appropriate business or personal instance of the application, or access the appropriate business or personal data to fulfill the user's needs.

In an embodiment, MPL 110 can store one or more passwords used to launch applications. For example, some applications may require a password before they are launched. MPL 110 can store a personal password and/or a business password for each supported application and can provide the appropriate password to the application when the application is launched. In an embodiment, MPL 110 can require a separate password to be entered on boot up before MPL 110 is launched to provide an additional layer of security. After the user has entered the password, MPL 110 enables the user to launch business and/or personal applications without having to log in and out additional times.

### 4. CHANGING PERSONAS

In an embodiment, MPL 110 can also store a current default persona (e.g., a business persona or a personal persona) for a user and can instruct computing device 100 to launch applications under the default persona if computing device 100 detects that a user selected one of icons 202 to launch an application but did not press and hold the icon to initiate a dwell event. For example, a user may press icon 202e for a calendar application but may not press and hold icon 202e to pop up a menu (e.g., menu 204). MPL 110 can then initiate a launch of the calendar application under the default persona.

For example, the default persona can be the personal persona when computing device 100 first boots up and/or when the user first logins in. In an embodiment, MPL 110 can provide the user with an option to switch the default persona. For example, MPL 110 can instruct computing device 100 to display an icon in a system tray or a notification bar indicating the current persona being used. In an embodiment, the user can click this system tray icon (or, e.g., another icon associated with MPL 110) and can instruct MPL 110 to change the default persona. For example, a user can change the default persona from a personal persona to a business persona and can then click icon 202e for the calendar application. MPL 110 can then launch a calendar application under the user's business persona since the default persona was changed.

FIG. 2C is a block diagram showing a system tray of a computing device displaying a default persona in accordance with an embodiment of the present disclosure. FIG. 2C shows system tray 208 of computing device 100. Icon 210 is displayed in system tray 208 to indicate that the default persona is a personal persona and that applications will automatically be launched under the user's personal persona if a dwell event is not detected.

FIG. 2D is a block diagram showing a menu for changing a default persona in accordance with an embodiment of the present disclosure. If a user clicks icon 210, MPL 110 can launch a persona menu 212 with an option to change the default persona. If the user elects to select a business persona as a default persona, MPL 110 changes icon 210 to a business persona icon and will automatically launch applications under the user's business persona if a dwell event is not detected.

In an embodiment, MPL 110 can automatically change the default persona to the last persona used. For example, if MPL 110 launched under a personal persona, but the user elected to launch an application under a business persona, MPL 110 can automatically change to a business persona without requiring the user to change the default persona. For example, if a user launches a calendar application under a business persona and then selects icon 202c for an email application without initiating a dwell event to pop up a menu, MPL 110 can launch the email application under the user's business persona.

Additional personas other than business personas and personal personas can also be supported in accordance with embodiments of the present disclosure. For example, a single user may have three or more personas. For example, in an embodiment, a single user may have a business persona, an unsecure personal persona, and a secure personal persona. A user can configure MPL 110 to support more or fewer personas for a single user. In an embodiment, when an additional persona is added for a single user using MPL 110, menu 204 can show an additional option to launch the application under the added persona. In an embodiment, MPL 110 can support any number of personas for a single user. Alternatively, MPL 110 can be configured to support a maximum predetermined number of personas for a single user.

### 5. MPL WITH MULTIPLE USER SUPPORT

In an embodiment, MPL 110 can be configured to support multiple users. For example, a computing device, such as a tablet computer or a mobile device, may be used by several different users (e.g., members of a family), and a user may want to provide family members with access to certain applications without allowing family members to access other applications. In an embodiment, a user may want to allow his or her child to access personal data (e.g., games) on the computing device but not business data. In an embodiment, a primary user can configure permissions of MPL 110 to allow access to personal data (or specific applications) when another user logs on. In an embodiment, the primary user can be set when the MPL 110 is first installed on computing device 100. In an embodiment, when computing device 100 first boots up and/or when a user first logs in, MPL 110 launches under a default persona of the primary user. In an embodiment, MPL 110 can provide an option to switch users.

FIG. 2E is a block diagram showing a menu for switching users in accordance with an embodiment of the present disclosure. In FIG. 2E, a user can access a change user menu 214 (e.g., by clicking icon 210 in system tray 208). In an embodiment, when a user clicks icon 210, MPL 110 can open change user menu 214. Alternatively, in an embodiment, when a user clicks icon 210, MPL 110 displays a menu to either change a persona, to change a user, or to cancel. If the user selects the option to change a persona, MPL 110 can open persona menu 212 shown in FIG. 2D. If the user selects the option to change a user, MPL 110 can open menu 214.

As shown in FIG. 2E, menu 214 displays options 216 for changing users. For example, change user menu 214 can display members of the primary user's family, friends, coworkers, or other users the primary user wants to have access to data on computing device 100. For example, if the primary user is a man named Mark, he may want to allow his wife Diane 216c or his son David 216d to use certain applications, and, in an embodiment, MPL 110 can allow a user charge the active user to Diane 216c or David 216d. In an embodiment, change user menu 214 can also display multiple personas for an individual user. For example, in an embodiment, change user menu 214 can display an option to change between Mark's business persona 216a and Mark's personal persona 216b. In another embodiment, change user menu 214 only displays users, and personas are configured using a different menu (e.g., using persona menu 212). While only one persona is shown for Diane and David in FIG. 2E, it should be understood that any user can have multiple personas in accordance with an embodiment of the present disclosure.

In an embodiment, MPL 110 can require new users (e.g., Diane 206c or David 206d) to enter a password before allowing the user change. For example, Diane's password is entered before allowing the user change to Diane. If the user is changed back to the primary user (e.g., Mark), the primary user's password can be entered before allowing the user change. In an embodiment, once a user change has occurred, applications will launch under the user's default persona. For example, if the user is changed to Diane 216c, email application 202c will launch under Diane's default persona if icon 202c is selected without initiating a dwell event.

In an embodiment, MPL 110 can allow an application to be launched under a different user without changing the currently selected user. For example, Mark may want to provide Diane with the option to quickly access her email without having to switch users using MPL 110. FIG. 2F is a block diagram illustrating a menu displaying a variety of user options for launching an application in accordance with an embodiment of the present disclosure. As shown in FIG. 2F, menu 204 can include additional options 206d and 206e for launching an application under another user. For example, if Mark initiates a dwell event on calendar icon 202e, menu 204 can pop up and can display options for launching a calendar application as Diane 206d or as David 206e.

In an embodiment, a user can configure MPL 110 to set user permissions to enable some users to launch applications under another user without entering a password. For example, in an embodiment, MPL 110 can be configured to enable Mark to launch a calendar application as Diane without requiring that Diane's password to be entered. For example, Diane's permissions in MPL 110 can be configured to allow other users (e.g., all users or specific users) to access certain applications (e.g., her calendar application) without entering a password.

In an embodiment, if MPL 110 has been configured to prevent certain users from accessing certain applications, those applications are not displayed when users are switched. For example, if the user is switched to Mark's son David, screen 200 can be configured to only display phone icon 202a, game icon 202d, and calendar icon 202e. Additionally, in an embodiment, menu 204 does not display options to launch an application under a user if MPL 110 has been configured to prevent access of that user to the application. For example, in an embodiment, if a user initiates a dwell event on email icon 202c and if MPL 110 has been configured to prevent David from accessing the email program associated with email icon 202c, menu 204 does not display an option to launch the email program as David.

### 6. MPL PERMISSIONS

In an embodiment, the primary user can configure the permissions of MPL 110 to instruct MPL 110 which users are allowed to access certain applications. In an embodiment, these permissions can first be configured when MPL 110 is installed and can be modified at a later time. For example, in an embodiment, a user can configure permissions (e.g., in a permissions file accessible by MPL 110) via a user interface provided by MPL 110.

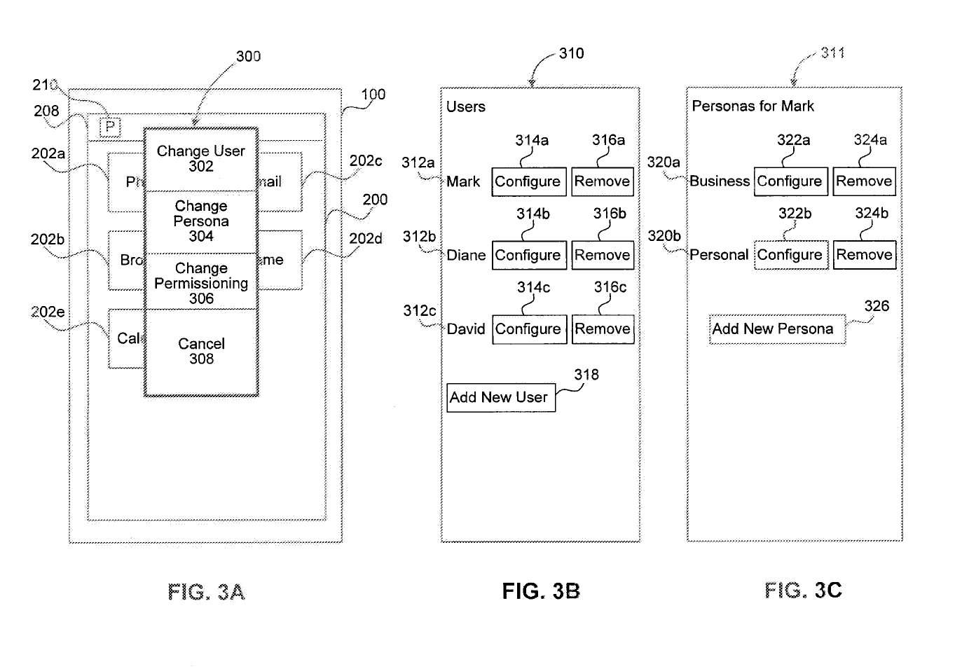

FIGS. 3A-3C show exemplary block diagrams for configuring permissions in accordance with an embodiment of the present disclosure. It should be understood that the options shown in FIGS. 3A-3C are provided by way of example and that MPL permissions can be configured using a variety of techniques in accordance with an embodiment of the present disclosure.

FIG. 3A shows a block diagram illustrating a menu for changing users, personas, and permissions in accordance with an embodiment of the present disclosure. In an embodiment, when a user clicks icon 210, MPL 110 can initiate a display of menu 300, showing an option for changing a user 302, an option for changing a persona 304, an option for changing permissions 306, and an option for cancelling the menu 308. In an embodiment, selecting change user option 302 can initiate a display of user menu 214. In an embodiment, selecting change persona option 304 can initiate a display of persona menu 212.

FIG. 3B shows a diagram illustrating a menu 310 for configuring users in accordance with an embodiment of the present disclosure. In an embodiment, menu 310 is launched on computing device 100 when a user selects change permissions option of menu 300. As shown in FIG. 3B, menu 310 shows users 312 recognized by MPL 110. Each user can be configured 314 or removed 316. Menu 310 also provides the option to add a new user 318.

FIG. 3C shows a diagram illustrating a menu 311 for configuring personas in accordance with an embodiment of the present disclosure. In an embodiment, menu 311 is launched on computing device 100 when a user selects a configure option 314 of menu 310. For example, if a user selects configure button 314a for Mark 312a, menu 311 can display personas currently recognized for Mark. In an embodiment, if a user does not have multiple personas, menu 311 can display a default persona for the user.

As shown in FIG. 3C, Mark has a business persona 320a and a personal persona 320b. In an embodiment, menu 311 provides an option to configure 322 or to remove 324 each persona. Menu 311 can also provide an option to add a new persona for the user 326. In an embodiment, the permissions of MPL 110 can be configured for each user and/or persona using configure option 322. For example, using configure option 322a, Mark can configure which applications and data are accessible under Mark's business persona. Mark can set which applications should be launched by default under his business persona, and these applications may differ from the applications launched by default under his personal persona. For example, in an embodiment, Mark may have a different email program that should be launched under a business persona and a personal persona, and when Mark clicks email icon 202c, the appropriate program can be launched depending on which persona Mark is using. Alternatively, in an embodiment, Mark can configure MPL 110 to display an icon for a first email program only under his business persona and a second email program only under his personal persona.

In an embodiment, configure options 322 can also be used to set permissions for other users. For example, Mark may want to allow David to access a game application but not email applications. Using configure button 314c of FIG. 3B, Mark can open a menu for changing David's permissions and can allow David access to game applications. In an embodiment, permissions can only be configured by the primary user. Alternatively, in an embodiment, the primary user can allow other users to modify permissions as well.

### 7. METHOD FOR LAUNCHING AN APPLICATION USING AN MPL

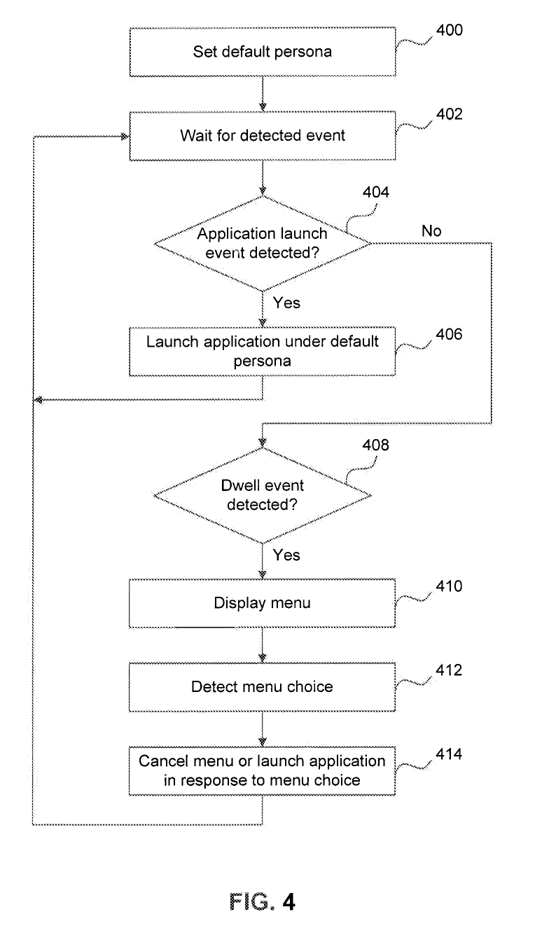

FIG. 4 is a flowchart of a method for launching an application using a multi-persona launcher in accordance with an embodiment of the present disclosure. In step 400, a default persona is selected. For example, when computing device 100 boots up or a user logs in, MPL 110 can automatically launch under a user's personal persona. Additionally, as discussed above, a user can reconfigure the default persona manually.

In step 402, MPL 110 waits for a detected event. For example, MPL 110 can wait for a user to select an application to launch under a default persona or for a dwell event initiated by a user. If MPL 110 detects an application launch event in step 404 (e.g., in response to a user pressing calendar icon 202e), MPL launches the application under the default persona in step 406. The method then returns to step 402 to wait for a new defected event.

If MPL 110 detects a dwell event in step 408 (e.g., in response to a user pressing and holding calendar icon 202e), MPL 110 displays a menu (e.g., menu 204) in step 410. In an embodiment, MPL can access persona information (e.g., which personas are supported for the current user) in response to this dwell event and can use this persona information to generate menu 204. MPL 110 detects the user's menu choice in step 412. For example, this choice can be a choice to launch an application under a business persona 206a, to launch an application under a personal persona 206b, or to cancel the menu 206c. IL an embodiment, menu 204 can also display options to launch the application under a different user. In step 414, MPL 110 responds to the user's choice by launching the application under the appropriate user, by launching the application under the appropriate persona, or by cancelling the menu. The method then returns to step 402 to wait for a new detected event.

### 8. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The representative signal processing functions described herein can be implemented in hardware, software, or some combination thereof. For instance, the signal processing functions can be implemented using computer processors, computer logic, application specific circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g. software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, and further the invention should be defined only in accordance with the following claims and their equivalents.

What is claimed is:

1. A method, comprising:
detecting, using a processing device, an event for launching an application;
accessing, using the processing device, persona information in response to detecting the event; and
displaying, using the processing device and based on the persona information, a menu, wherein the menu contains a plurality of options for launching the application under a plurality of personas.

2. The method of claim 1, wherein the event is a dwell event input onto a mobile device.

3. The method of claim 1, further comprising:
detecting a selection of a first option in the plurality of options, wherein the first option corresponds to a first persona in the plurality of personas; and
launching the application under the first persona.

4. The method of claim 3, wherein a default persona is set as a second persona, and wherein the application is launched under the first persona without requiring a user log in under the first persona or a user log out under the default persona.

5. The method of claim 1, further comprising:
detecting a second event for launching the application; and
launching the application under a default persona in response to detecting the second event.

6. The method of claim 5, further comprising:
changing the default persona.

7. The method of claim 1, wherein the menu contains an option to launch the application under a different user.

8. A method, comprising:
detecting, using a processing device, a first event for launching an application;
launching, using the processing device, the application under a default persona in response to detecting the first event;
detecting, using the processing device, a second event for launching the application;
accessing, using the processing device, persona information in response to detecting the second event;
displaying, using the processing device and based on the persona information, a menu, wherein the menu contains a first option for launching the application under a first persona and a second option for launching the application under the default persona;
detecting a selection of the first option; and
launching the application under the first persona in response to detecting the selection of the first option.

9. The method of claim 8, further comprising:
receiving a request to change the default persona; and
displaying a second menu in response to receiving the request, wherein the second menu contains a third option for changing the default persona to the first persona.

10. The method of claim 8, wherein the menu contains a third option for launching the application under a second user.

11. The method of claim 10, further comprising:
receiving a request to change an active user; and
displaying a second menu in response to receiving the request, wherein the second menu contains a third option for changing the active user to a first user.

12. The method of claim 8, further comprising:
receiving a request to change permissions; and
displaying a second menu in response to receiving the request, wherein the second menu contains a third option for changing first permissions of the first persona and a fourth option for changing second permissions of the default persona.

13. The method of claim 8, further comprising:
receiving a request to change permissions; and
displaying a second menu in response to receiving the request, wherein the second menu contains a third option for changing first permissions of an active user and a fourth option for changing second permissions of a first user.

14. The method of claim 8, wherein the default persona is a personal persona, and wherein the first persona is a business persona.

15. A computing device comprising:
a processor; and
a multi-persona launcher (MPL) module, wherein the MPL module is configured to:
detect an event for launching an application,
access persona information in response to detecting the event, and
display, based on the persona information, a menu, wherein the menu contains a plurality of options for launching the application under a plurality of personas.

16. The computing device of claim 15, wherein the computing device is a mobile device, and wherein the event is a dwell event input onto the mobile device.

17. The computing device of claim 15, wherein the MPL module is further configured to:
detect a selection of a first option in the plurality of options, wherein the first option corresponds to a first persona in the plurality of personas; and
launch the application under the first persona.

18. The computing device of claim 17, wherein a default persona is set as a second persona, and wherein the application is launched under the first persona without requiring a user log in under the first persona or a user log out under the default persona.

19. The computing device of claim 15, wherein the MPL module is further configured to:
detect a second event for launching the application; and
launch the application under a default persona in response to detecting the second event.

20. The computing device of claim 15, wherein the menu contains an option to launch the application under a different user.
